(19) United States
(12) Patent Application Publication
(10) Pub. No.: US 2008/0177669 A1
(43) Pub. Date: Jul. 24, 2008

(54) Methods related to engagement of service providers

(76) Inventor: T. Thaddeus Marshall, Tampa, FL (US)

Correspondence Address: Howard IP Law Group, P.O. Box 226, Fort Washington, PA, 19034, US

(21) Appl. No.: 12/008,095

(22) Filed: Jan. 7, 2008

Related U.S. Application Data
(60) Provisional application No. 60/883,677, filed on Jan. 5, 2007.
(60) Provisional application No. 60/886,172, filed on Jan. 23, 2007.

(51) Int. Cl. G06Q 30/00; G06Q 40/00; G06Q 20/00

(52) U.S. Cl. 705/80; 705/40

(57) ABSTRACT

A method includes receiving from a potential consumer of services information related to a matter pertaining to the subject matter of the services; storing the information in a storage medium; communicating to a provider of services at least a portion of the stored information; receiving an indication that the provider and the potential consumer have agreed that services will be provided; agreeing with the potential consumer for a loan having a principal amount equal to selected expenses, the loan to be repaid exclusively out of any proceeds of the consumer arising out of the services; and providing funds for the selected expenses, which selected expenses arise out of an event related to the subject matter of the services.

### RELATED APPLICATIONS

This application claims the benefit of U.S. Provisional Patent Application Ser. No. 60/883,677, filed Jan. 5, 2007, and U.S. Provisional Patent Application Ser. No. 60/886,172, filed Jan. 23, 2007, both of which applications are incorporated by reference herein in their entireties. This application also incorporates by reference my copending application Ser. Nos. 10/375,460, filed Feb. 27, 2003; and Ser. No. 10/047,426 filed on Jan. 14, 2002, and abandoned Ser No. 09/722,904, filed on Nov. 27, 2000.

### FIELD OF THE INVENTION

This invention is in the field of arranging for providing services to consumers, and particularly non-recourse loans for use by consumers in need of legal services.

### BACKGROUND

Customers for services often have difficulty in benefiting from reduced fees for various services. In one example, customers in need of legal services may have difficulty in selecting and identifying counsel to provide services. A prospective customer for legal services will in many cases need a personal injury attorney, for example. One method for selecting a personal injury lawyer is through word-of-mouth recommendations by family, friends and co-workers. However, such recommendations do nothing to empower consumers in need of a personal injury lawyer to reliably obtain legal representation on a significantly discounted fee basis.

Virtual strangers such as tow truck drivers, emergency room and hospital personnel and others who encounter people after accidents sometimes have inappropriate arrangements with law firms that result in benefits being conveyed to the non-lawyers who generate personal injury case referrals for law firm that eventually signs up the client. However, such referrals do nothing to empower consumers in need of a personal injury lawyer to reliably obtain legal representation on a significantly discounted fee basis.

Attorneys and law firms advertise aggressively on television, radio, in the phone book and on the internet. However, such advertisements do nothing to empower consumers in need of a personal injury lawyer to reliably obtain legal representation on a significantly discounted fee basis.

For example, referral services operate as free services for consumers that direct consumers who are in need of legal services to a limited group of law firms. In some cases, state bar associations offer or sponsor referral services. In other cases, the law firms that are the beneficiaries of the legal case referrals underwrite the cost of advertising and promotion of the “free” referral service in order to attract consumers to the referral service. However, such referral services offer a limited selection of law firms from which consumers are required to choose and they also do nothing to empower consumers in need of a personal injury lawyer to reliably obtain legal representation on a significantly discounted fee basis.

Certain companies offer various forms of prepaid legal services or “discounted” legal services to consumers. For example, certain pre-paid legal services typically require that consumers pay monthly fees to a company that has contracted with certain law firms selected by the company rather than by the consumer who is in need of legal services to handle the legal needs of its paying subscribers. Alternatively, in some cases, consumers must use or purchase a specific product or service such as a credit card in order to gain access to these supposed discounted legal services that are offered as a “cardholder benefit” by such credit card providers.

In some cases, certain online providers of services offer consumers an online forum and the ability for consumer to present certain information to prospective lawyers regarding their potential legal case so as to engage the services of a selected lawyer. However, such services do nothing to alter the fact that lawyers routinely perform non-legal tasks as part of their agreement to represent their clients such as the task of gathering medical records and bills on behalf of their clients in accident cases, among others. Such services also fail to change the fact that lawyers are in a position to negotiate relatively high standard legal fees based on the argument that they will pay costs out of their own pocket to gather medical records and bills.

In virtually all of these contexts, the companies rather than the consumers select the law firms that provide limited, defined legal services on behalf of the consumers who are in need of such legal services and none are effective at producing a consistent result that justifies acceptance of significantly reduced legal fees by lawyers based on economic cost offsets that are produced by these proposed methods. In fact, in regard to benefit programs, they do nothing to empower consumers in need of a personal injury lawyer to reliably obtain legal representation of their own choosing on a reduced legal fee basis and most require that consumers select a law firm that participates in the service at some level unlike the proposed methods that empower consumers.

After an accident, the consumer is at a distinct disadvantage when it comes to retaining a lawyer on a reduced contingent legal fee basis for several reasons that demonstrate the need for the proposed methods and services. In fact, consumers retain personal injury lawyers precisely because those lawyers are effective negotiators which makes it that much more difficult for a consumer who has been traumatized in an accident to benefit from a discounted contingent legal fee under any circumstances contemplated by existing methods. Alternatively, non-recourse loans are viewed by many as abusive to consumers who pay significant fees for the use of funds while a legal case remains pending. Lenders spend money marketing non-recourse loans to existing clients of lawyers often by promoting them to lawyers who earn fees for that purpose.

### SUMMARY OF THE INVENTION

At least the above disadvantages of the prior art are addressed by a new form of non-recourse loan that may include a pledge to fund a loan up to a certain amount for defined restricted-purposes so that the non-recourse loans are used to pay a vendor to perform services that offset the costs and burden on the lawyers to gather medical records and bills for example and thus justify a significant fee reduction as a result.

A method includes receiving from a potential consumer of services information related to a matter pertaining to the subject matter of the services; storing the information in a storage medium; communicating to a provider of services at least a portion of the stored information; receiving an indication that the provider and the potential consumer have agreed that services will be provided; agreeing with the potential consumer for a directed-purpose loan or credit line, which will be drawn on to pay selected expenses that may or may not not be needed, the loan funds to be accessed and specifically used to pay such expenses directly to a third party vendor that may be identified. An advantage of the present method is that the legal service provider is relieved of the cost and burden of performing non-legal service related tasks. and with funds used by the lender to pay funds to the vendor for the restricted purposes and to be repaid by the consumer exclusively out of any proceeds of the matter arising out of the need for services; and providing funds to be paid directly for the selected expenses, which selected expenses arise out of an event related to the subject matter of the services.

A method related to engagement of a provider of services, including the steps of receiving from a potential consumer of the services information related to a matter pertaining to the subject matter of the services; storing the information in a storage medium; communicating to one or more designated potential lenders including one or more individuals or collective groups of individuals who may provide funds as potential lenders (hereinafter referred to as the “lender”) at least a portion of the stored information, including identifying information for the customer; communicating to a provider of services at least a portion of the stored information, excluding contact information for the customer, and providing conditions for furnishing contact information; receiving and evaluating a response from the provider; receiving and evaluating one or more responses from potential lenders; based on the step of evaluating the provider response, providing customer contact information to the provider; receiving an indication that the provider and the potential consumer have agreed that services will be provided; and based at least on the received responses from the potential lenders, recording information relating to an agreement between the potential consumer for a loan from the one or more lenders having a principal amount equal to selected expenses, the loan to be repaid possibly exclusively out of any proceeds of the consumer arising out of the services. The lender may notify the legal service provider of payments made by the lender to document the loan to be repaid at settlement.

### BRIEF DESCRIPTION OF THE FIGURES

FIG. 1 is a schematic diagram of participants in a method related to engagement of counsel.

FIG. 2 is a process flow diagram of a high level process flow of a method relating to engagement of counsel according to an embodiment of the invention and involving the participants of FIG. 1.

FIG. 3 is a process flow diagram of an embodiment of a method relating to engagement of counsel.

FIG. 4 is a process flow diagram of methods in the embodiment of FIG. 3.

FIG. 5 is a process flow diagram of methods in the embodiment of FIG. 3.

FIG. 6 is a process flow diagram of methods in the embodiment of FIG. 3.

FIG. 7 is a schematic diagram of participants in an alternative method.

### DETAILED DESCRIPTION

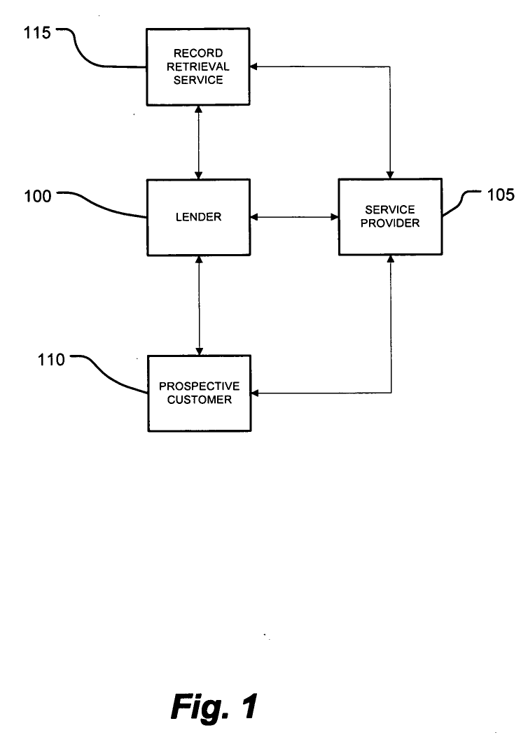

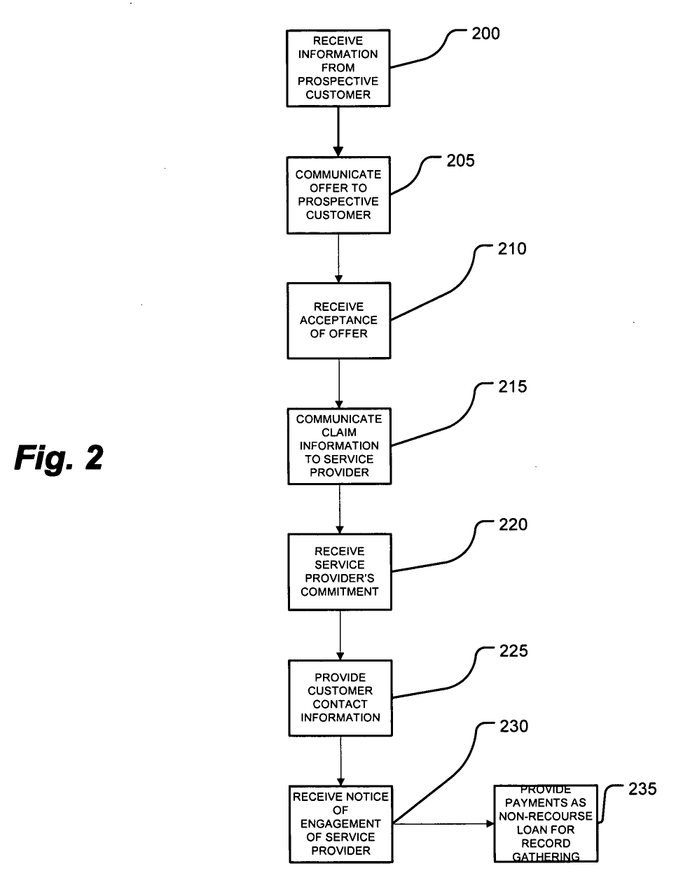

Referring now to FIGS. 1 and 2, participants in a method related to engagement of service providers are schematically illustrated, and a high-level process flow of a method related to engagement of service providers is illustrated.

In an implementation, a provider of lending or credit services 100 may implement a method. The method may be implemented employing one or more computers.

In an implementation of a method, information is received by the lender 100 from a prospective customer 110 of legal services at step 200. The information received pertains to the identity of the prospective customer, the circumstances relating to the claim, such as type of incident, location, and the like. This information may be received in any suitable form.

The customer may be any person or entity that has the right to pursue the claim. By way of example, the customer may be an individual, an estate of a deceased individual, a guardian for a minor or other individual, a surviving relative of a deceased individual, or a representative of any of the foregoing.

The lender 100 may then offer an agreement to the prospective customer 110, as indicated by step 205. Under the offer, the lender agrees to lend the customer funds for a specific purpose, such as to provide or obtain services in the nature of obtaining of documents and information related to the circumstances relating to the claim. The offer may provide for the lender to provide the services, or to engage a record firm to provide the services. The loan may be in the form of a loan to be paid out of specified funds. For example, the specified funds may be any recovery of the consumer relating to the consumer's claim. In consideration, the customer may agree to repay the loan, and may further pay a fee at the time of agreement.

The loan offer may be predicated on certain conditions. The offer may be for a loan pledged to be available but then funded only upon presentation of defined case-related costs. The loan repayment formula may include interest charges at a fixed or floating rate, and/or may be defined as a percentage of the recovery of money stemming from the pending legal case. For example, the loan offer may be predicated on the customer's engagement of counsel for representation in connection with the claim. By way of example, the loan offer may be conditioned on the customer's engagement of counsel for representation in connection with pursuing a claim for damages resulting from personal injury arising out of such incidents as an accident, possibly on a reduced legal fee basis.

The loan may be understood as a line of credit to be used for a directed purpose. The directed purpose may be the retrieval and copying of records, for example. The use of the funds for the directed purpose may further be assured by requiring that the lender make payment to the provider of record retrieval or other services, and not to the consumer. As the amount that is in fact lent depends on the amount charged by the service provider, and is not known at the time of agreement, the loan may be understood as a line of credit. As noted, a further directed purpose is to refund to the consumer the amount of the initial fee payment by the consumer.

The lender may receive the customer's indication of acceptance of the offer as indicated by step 210. Acceptance may be indicated in any manner recognized by law, including without limitation signature and return of paper documents, and indicating assent electronically. If a fee is charged, the fee payment may be made in any suitable manner, including via paper check, ACH, cash, or online or telephone credit card or debit card payment. In an implementation, the offer, acceptance, and payment may be made via a web browser connected via the Internet or one or more alternative or additional networks.

In a further step, a service provider may facilitate communication between the customer and a prospective service provider. The communication may be directed by the lender, or by an agent acting on behalf of the lender. In another example, a sample communication may be furnished by the lender to the customer for use by the customer in contacting a service provider directly. In an example, a communication may be provided that provides contact information for the customer and certain information concerning the basis for the claim. In an example, the information may include the time and date, location and general description of an accident, the nature of the injury which creates the claim and the existence of third party liability insurance or uninsured/underinsured motorist coverage to pay damage claims. The communication may indicate that the lender has agreed to provide a loan for certain costs, such as costs associated with record gathering on behalf of accident victims.

In the process flow illustrated in FIG. 2, the communication to the prospective service provider may omit customer contact information, and place conditions on providing the customer contact information. By way of example, the service provider may be required to furnish an agreement to use the lender's selected record retrieval service. By way of further example, the service provider may be required to provide an agreement to provide particular terms of engagement with the customer. By way of example, the terms of engagement may include a cap on the fee of the service provider. The cap may be expressed as a percentage of the customer's eventual recovery, if any. The cap may be lower than the prevailing fee for such services in the service provider's geographic area.

In an embodiment, as discussed below, the lender may employ various rating and incentive techniques for selection of one or more service providers to receive a communication.

In an embodiment, the lender may receive a suitable response from one or more service providers. The lender may evaluate the response for compliance with requirements. If the response is acceptable, such as a commitment, as indicated by block 220, the lender may provide contact information of the customer to the service provider, as indicated by block 225.

The lender may condition entering into the loan agreement on receiving confirmation that the customer has engaged a service provider. The lender may require confirmation of the terms as well.

In an implementation, the lender may require coordination of the services of obtaining records with the service provider.

In an implementation, the record retrieval service obtains the records and provides a copy of the records to the legal services provider. The record retrieval service then bills the lender. The lender pays the record retrieval service, and charges the amount of the payment as a non-recourse loan. The lender notifies the legal services provider of the amount of the payment, so that the legal service provider may designate the loan amount to be repaid out of the recovery from the case.

The lender may lend funds, in the form of payments to a record retrieval services provider 115, for services approved by the service provider.

It will be appreciated that other purposes may be permitted for use of the funds. For example, the funds may be used for other expenses associated with personal injury litigation, such as court costs, experts or court reporters. Additional funds, or up front, may be used for other general purposes including those that are unrelated to litigation, but related to an event related to the claim that results in the litigation. By way of example, purposes may include funeral expenses, medical expenses, costs of medical equipment, costs of modifying homes as a result of temporary or permanent disabilities, and other expenses arising out of an injury.

In an embodiment, an initial fee charged by the lender or other service provider may be repaid to the consumer out of the loan proceeds. Thus, the directed purpose of the loan may include payment of the initial fee for the service.

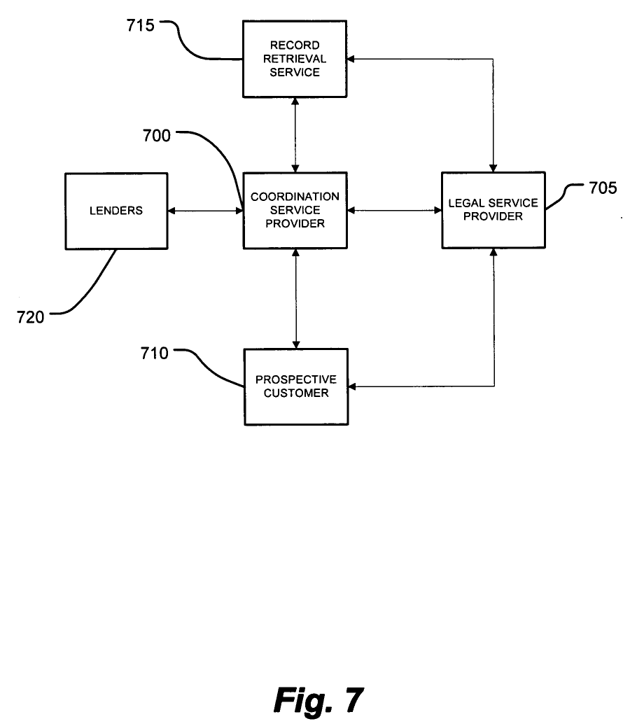

In an embodiment, illustrated schematically in FIG. 7, a peer-to-peer model for loans may be implemented. In the peer-to-peer loan model, the lender (or lenders) 720 is separate from the provider 700 of the services of maintaining the registration of customers 705, and providing information and coordination with legal service providers 705 and record retrieval services 710. By way of example, a service provider 700 may notify a third party source of funds 720 when a request for services is received. In an implementation, the third party source of funds may be a group of other individuals or community groups. Those individuals may then provide the funds for the loan.

The consumer in a peer-to-peer implementation may agree to a privacy waiver to permit identifying information to be provided to potential lenders. Thus, potential lenders may include subjective information concerning the victim in determining whether to provide a loan. A service provider may assign an interest rate or return on investment and track responses to a request for funds; in the event of a low level of favorable responses, then the service provider may decide not to proceed forward, as such a low level of favorable responses may indicate that the customer is untrustworthy, or that information in the community regarding the accident puts liability in question. Alternatively, a service provider may provide results of the evaluation to lenders, who can then decide whether or not to provide the loan. Community pressure may also tend to provide an incentive for candor and cooperation with counsel. In certain cases, the lender may optionally fund loans directly for use in legal cases not otherwise accepted on a peer to peer basis and/or the lender may insure results or credit losses in cases when loan funds are used as envisioned and the legal case is dropped before a successful result is achieved.

In this implementation, for example, the lenders may provide the funds to the service provider, who then deposits the funds on behalf of the lenders, and disburses funds to the record retrieval service as appropriate. In another implementation, the lenders may agree to provide the funds to the service provider on demand, such as upon receipt of an invoice, acceptable to the service provider, from the record retrieval service.

A customer may have designated a particular lender. Such lenders may be, for example, funds of churches, fraternal organizations or other community organizations. In such an embodiment, individual members of the organization may register. The customer seeking counsel may identify his or her group as part of the registration process. In an embodiment, a group of individuals may all register as potential lenders for one another.

In an embodiment, all or members of a group may be contacted when any member of the group reports an accident or other need for counsel. If the lender is a designated fund, the group members may be provided an opportunity to respond with a recommendation as to whether or not to provide the loan. The response may be a simple yes or no response, or may be more nuanced, as on a scale with any given number of units. The response may be collected by the service provider and reported to the lender.

In an embodiment, a service provider may guarantee to the attorney that the line of credit will be available in the peer-to-peer context.

The interest rate of the peer-to-peer lender may be set by the loan arrangement service provider.

In any embodiment, some loans may fail. Other business arrangements may be provided, such as additional loans or products made available to the customers, so that additional returns may be earned from customers with successful cases.

It will also be appreciated that any of the tracking and scoring methods described in my prior applications may result in one or more scores or values associated with the customer. These scores or values may be accessed and included in an algorithm in determining whether or not to provide a loan, or in determining, for example, a cap on a loan. For example, an individual with relatively higher point totals for promptness in payment of bills, or for participation in community activities, by way of non-limiting examples, may be given a higher probability of being approved for a loan, or a higher loan amount cap.

This embodiment is advantageous in empowering existing or newly-defined communities to demand lower legal fees. In addition, lawyer reactions may be tracked and scored and made known to all or some of the program members and lenders. This information may or may not be made available to other customers, as well as to the general public.

In an implementation, lawyers or law firms who agree to the conditions may earn volunteerism credits plus other good will and benefits.

In an implementation, the user may be provided an opportunity, such as through a form at the website, to provide comments and evaluations engaged lawyers.

Individual may also receive credits or points for their promptness in responding to requests to fund loans, for willingness to provide funding, for recipients in connection with quality of claims and cooperation with counsel and others involved in the legal process. Lenders may also be tracked in connection with the quality of their performance, such as in timeliness and accuracy of payments to record retrieval (or other service) providers.

In an embodiment, customers may agree to provide a portion of a recovery to be donated or pledged and then loaned to a fund for future loans. Cooperation with such a suggestion may result in rewards.

In an embodiment, insurance may be made available to lenders in the event that there is no recovery, or the recovery is too small to repay the principal and interest in its entirety.

In an embodiment, the service provider may offer or provide promotions or referrals for uninsured motorist coverage, or other coverages to provide in the event that a responsible party lacks insurance or other resources.

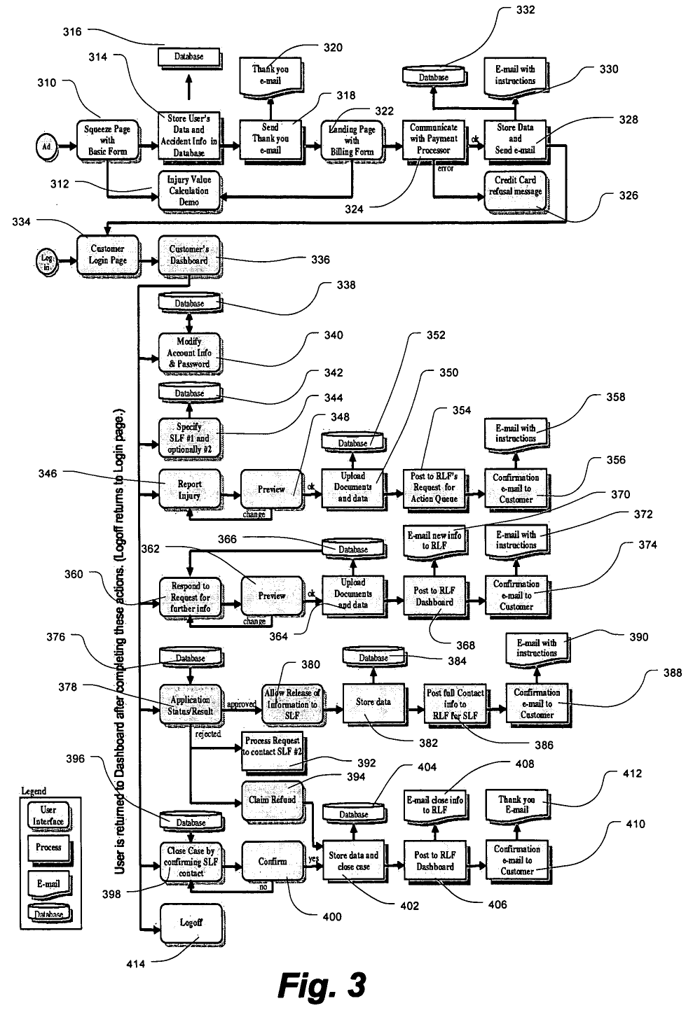

Referring now to FIG. 3, an exemplary implementation will be discussed. In this implementation, a website is provided. A prospective customer uses a browser to access the website. The customer initially has loaded a squeeze page 310. That page briefly describes the available service. This page may contain a link to a Demonstration Calculation ASP page 312. This page may provide access to an application which permits the user to select various types of accidents or injuries, and returns an expected award and an expected amount to be saved using the lender's services. The squeeze page 310 may include a basic registration form, that prompts the prospective user to provide, for example, name, contact information (such as e-mail address), and geographic location of injury. Once this and/or other information is entered and submitted by the Prospective Customer to the system, the prospective customer's browser will be redirected to another web page with more detailed information about the product and what type of communications and services to expect.

The information submitted by the Prospective Customer may be stored in an online database, using such database tools as MySQL, PostgressSQL or MSAccess, and sent to a remote database 316. An email may be sent to the new Customer. This email may include marketing information to attempt to cause the Prospective Customer to take other action.

The Prospective Customer is sent to the Landing Page 322. This page (Landing Page) contains more detailed information about the product/program but does not completely explain the entire process. This page also has a link to the Injury Case Value Calculator demonstration page 312. The bottom of the landing page contains a form which will allow the Prospective Customer to purchase the services program being offered using all available billing methods, including credit cards, Pay Pal, wire, etc. If the Prospective Customer decides to purchase the product, the customer fills in required information, such as Billing Name and address, Credit Card number and any additional information needed by the company processing the credit card purchase or otherwise needed to process other payment methods and complete the purchase transaction. This information is communicated to a payment processor 324. If a card or other information is refused, a refusal message 326 may be displayed. If the information is accepted, the lender's merchant account is notified of a successful purchase and funds are transferred into the appropriate account. An account number (basic numbering system) is generated and a new customer record is created within website database system. Resulting data may be stored, and an e-mail may be generated 328. The e-mail 330 may include thanking and confirming purchase of product, a new account number and password (same as account number) for this Customer.

The customer may be provided, via e-mail, a website link pointing to the exclusive Customer area. The login page may include basic instructions on how to access and logging on to the website in order to access their (Customer's) account.

It will be appreciated that payment for customer registration may be made by a third party, such as through a benefit from an employer, through membership in an organization, with purchase of a product or services, such as automobile club services, other roadside assistance services, or other services. The services may also be provided as an affinity program. The services may be branded with the name, marks and/or logo of a sponsoring organization in connection with such an affinity program.

The customer may then proceed to a customer login page 334. Once the customer logs in, the customer may be presented with a customer dashboard page providing a variety of options. Once Customer logs into the site, such as by entering an account number and password, he/she has the option to change the assigned password to another password at a password page 340. The customer may also change account information. Changes are recorded in a database 338.

Action Path by Customer Presently Needing Services.

If the customer presently needs to retain a selected attorney, such as a specific personal injury lawyer to handle a personal injury case, the customer may log on and access the customer website and enter or update the account, and provide or verify accident information. In an embodiment, it will be appreciated that other manners of communication, such as telephone, to live operator or intelligent voice response systems, may be employed.

If a new incident is being reported, the customer may select a report injury link that provides a report injury form 346. The report injury form may include fields for such information as full name of customer, full name of potential client if different from customer, relationship of customer to potential client, if different; address of customer and potential client, if different; phone numbers; appropriate times to call; preferred method of contact by lawyer (Lawyer calls customer only, customer calls lawyer only, both customer and lawyer call each other). The report injury form may further include fields, with or without drop down menus, for such information as Type of Accident, Location of Accident, Date of Accident, Details of Accident, and Details of Injury. The customer may be permitted to upload image files, such as photographs, video, scanned documents, and other image files, in any suitable format, such jpg, tiff, pdf, wmv or other formats. A field may be provided for the user to describe the uploaded files. Fields may be provided for such information as additional data, including other accident/injury-related information deemed desirable, and customer entry of desired percentage discounted legal fee that may be proposed/demanded within parameters. A preview page showing the input information may be presented 348. If the customer approves, then data and image files are uploaded 350, and stored in a database 352.

The system may provide information, such as in the form of pop-up windows, e-mails, or otherwise, for customers to view that may be included at each step or selected steps of the process of negotiating a discounted contingent legal fee may be introduced so as to fully inform consumers with text/video advice as such as similar case profile data, etc may be entered or made available for consideration by customers in the process. It is contemplated that an arbitrated discounted fee process to complement the disclosed methods may or may not be included.

The site may optionally provide the user an option of specifying one or more selected law firms (SLF) to be contacted 344. Fields for names, addresses, telephone, fax, e-mail and the like may be provided, and the information stored 342.

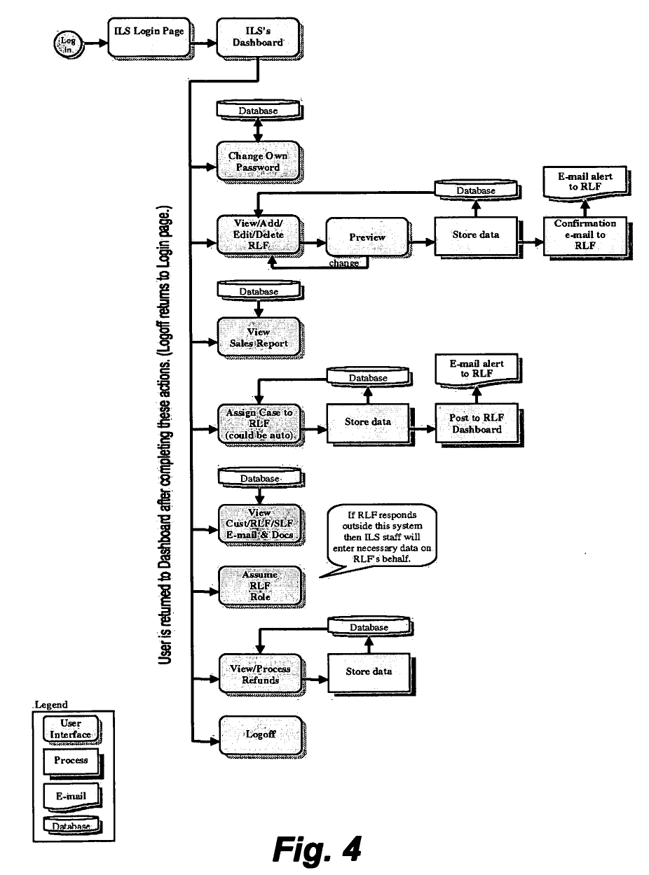

The lender, or non-lender service provider's process flow is shown in detail in FIG. 4.

Once the lender receives data relating to a new injury, the lender may post this information to a retained law firm (RLF) that provides services to the lender, request for action queue 354. A confirming e-mail may be sent to the customer 356. The information provided to the RLF may include various data input by the consumer, a discounted legal fee structure, or other information. It will be appreciated that in another embodiment the RLF may be omitted, or the service of contacting a selected law firm may be performed by non-lawyer service provider.

An email is sent 358 to the RLF, including these instructions. The e-mail may include some of the data input by the consumer, but lacks sufficient detail to identify the customer or person on whose behalf the customer has sought services.

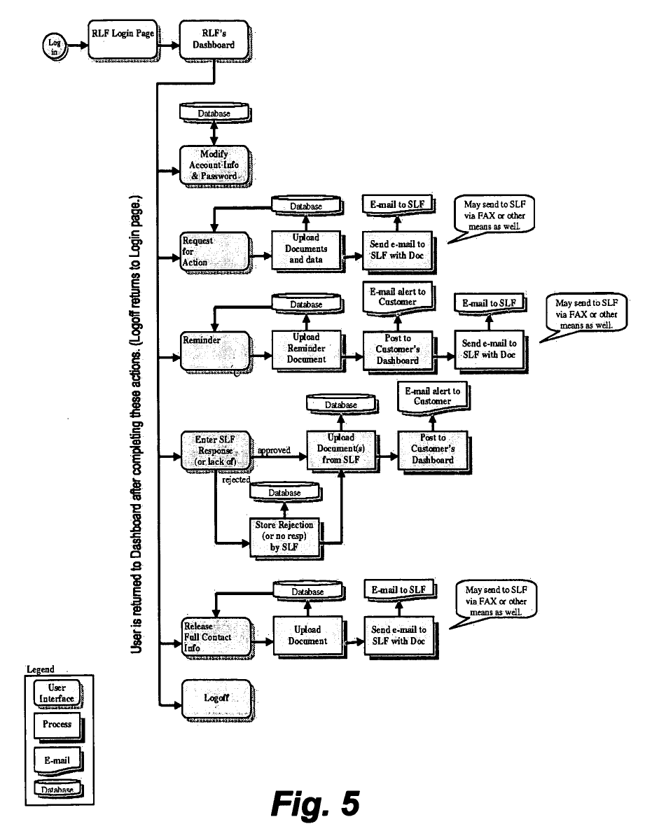

An exemplary process flow for the RLF is illustrated in FIG. 5. Upon receiving this information, the RLF may merge certain of the received data into a document to be forwarded to one or more SLF's. RLF assigns a new reference number to each customer data set and prepares new information to be inserted into a fax, emails, post to a secure link, etc)

The RLF sends the merged letter, by fax or other manner, to one or more SLF's. In an embodiment, the letter may include a requirement for agreement to particular fee arrangements. In an embodiment, the letter may include a requirement for the SLF to use a designated record retrieval vendor. The letter may include a description of the record retrieval services, the manner in which the services may be ordered, and information regarding the service provider. The document may include a suitable space for acceptance by the SLF.

In an embodiment, customers may optionally receive free or fee-based advice or input, in any manner, including displayed text, mailed or e-mailed text, displayed video, pop-ups, or otherwise, wherein the potentially legally relevant factors pertaining to their specific case parameters (or results of lawyer/law firm participation without problems being encountered by customers once the case is accepted) are addressed, discussed or presented in detail. Such advice or input may be posted to an account, or to a common forum for access by other customers.

In an embodiment, lawyer/law firm performance ratings may be assigned based on a wide variety of factors, including by way of example willingness to agree to proposed terms, promptness of reply, timeliness and completeness of replies to questions regarding record, and other factors. Another factor may include the lawyer or law firm's record of continuing with cases through to resolution; lawyers or law firms that withdraw from representation before resolution will receive a relatively lower rating.

In the example involving a faxed document, the document may consist of a fax cover sheet and a conformed, (merged) letter with some or all data provided by ILS such as selected descriptive information, possibly with no identifiable personal information that will enable RLF to provide to first or second SLF to evaluate potential injury case and decide to accept or reject the proposed terms of representation.

The document sent by RLF to SLF for counter signature must be received by RLF for additional steps to take place and a flag if no reply is received by a set time parameter.

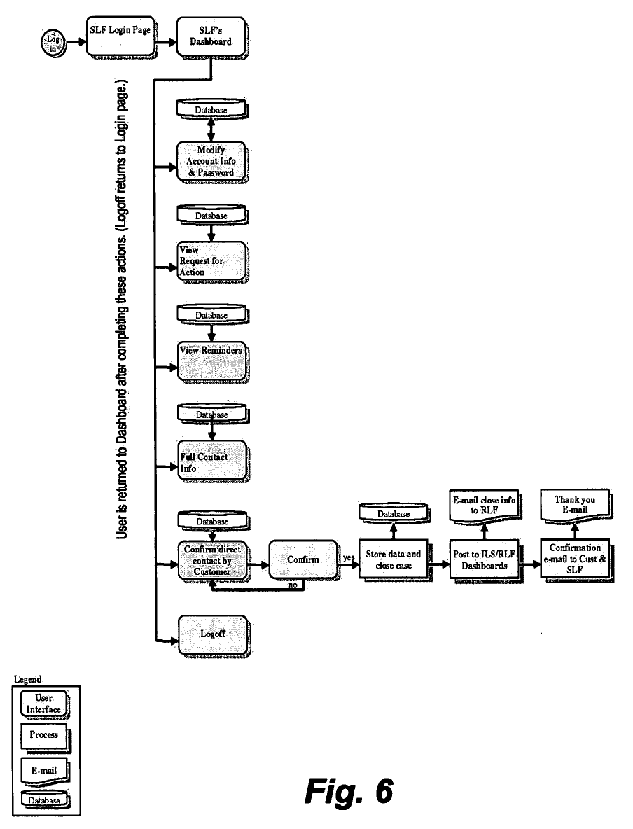

A process flow for an SLF is shown in FIG. 6. Thus, requests for action, reminders, contact information when received, and other information may be viewed.

RLF will take appropriate steps to assess status of requested reply from SLF to the request for representation on proposed terms such as email to SLF with second request indicated until reply is received.

RLF Reviews the Reply and RLF Takes Appropriate Action

Action Path of SLF if SLF accepts offer and counter-signs document and returns it to RLF by fax, email, log-on, etc

RLF notifies service provider of event and provides data to service provider in requested format with original customer access code to enable service provider to post the reply to the customer's account. If the SLF accepts the terms, the service provider notifies customer of receipt of counter-signed document by fax, email, log-on, or other suitable manner, and the reply is posted to the customer's account. The customer can then go to the application status/result page 378, which obtains the status information from database 376. If the customer approves, then the system indicates that all contact information is to be furnished 380, and appropriate data is stored 382, 384. The contact information may be posted for the SLF 386. A confirming e-mail may be generated and sent to the customer 388, 390.

In an embodiment, the document indicating SLF acceptance is scanned and uploaded into the system, and associated with the customer. If the SLF is not registered, a form document may be generated to provide details regarding how the SLF can contact the Customer. The RLF or the service provider may furnish this document to the SLF. This document may be stored within Customer's online account.

When the customer is notified, the customer may receive a copy of the countersigned letter is either attached to an email, or otherwise, such as available in the customer's online account. The email may contain a secure link to the countersigned document that is made accessible to customer in their updated account

The customer may be offered additional options or information regarding negotiating with the legal services provider at this point. The customer may be instructed to retain a copy of the countersigned letter received from ILS to ensure a record of the discounted legal fee is included in the retainer agreement signed by SLF on discounted legal fee terms as agreed. Alternatively, the customer may be required to check a box and acknowledge instructions by service provider, optionally through its RLF, to send another letter to the SLF with full customer contact information and authorizing SLF to contact the customer, possibly immediately or within a specified time frame or by using a preferred telephone number and/or within other parameters.

The service provider will confirm by affirmative response from either the customer or SLF that the customer's matter has been successfully handled to the satisfaction of the customer, the SLF or both parties. The service provider may extend additional product or service offers over time to maintain the customer relationship with education initiatives and other value

If the SLF fails to respond to the communication sent by RLF, a second communication may be sent, possibly with a higher level of attention or priority such as telephone contact flagged as needed to generate the desired response (i.e. a countersignature to the proposed terms set forth in the communication by RLF), possibly with added fees or other consideration for such added services and benefits. The customer may also be notified of a request for action form at this point.

Customer accesses the account, sees the “Request for Action” and provides any necessary response, including more specific information or other data within their online account.

If SLF rejects the terms proposed in communication sent to SLF by RLF, then, if the rejection is in writing, that written document may be posted to the customer account. An email is generated by RLF to notify the service provider of a response to account identified by reference code. The service provider may then send a request for action email is sent to the Customer. The service provider notifies customer of new account event information possibly including a document received from the SLF. As an alternative step, email itself may contain an image file of document. If reply is by phone, response is documented and customer is advised within parameters that may generate various responses to resolve the matter.

The customer, in response to a “Request for Action” response email, accesses the online account and provides the necessary information within their online account so preferred action is taken on behalf of customer. Options may include a second SLF being contacted and the process repeated 392, a refund being provided 394, or other options. Final outcomes are recorded by service provider and posted (possibly partially shielded for privacy) for other members, subscribers to see over time as a benefit for subscribers.

In the event of a report of contact between the customer and the SLF, of contact with refusal by the SLF, the refusal data may be moved from a database 396 to provide a close case screen 398. If the consumer confirms contact with the SLF 400, then the data is stored 402 to database 404, and the case is closed. The closing is communicated to the RLF dashboard 406, and an e-mail is provided to the RLF 408. A confirmation e-mail is sent to the customer 410, 412. A logoff is provided 414.

In the event of a favorable response, a “Request for Action” response email is sent from Customer to the service provider or customer accesses the account and provides the necessary information within their online account to initiate a request for a non-recourse loan. Loan options are presented and a quoted amount offered to customer

Appropriate forms are downloaded by customer or by SLF or forms are sent to SLF by service provider. Once an application is received, loans will be approved based on acceptable legal case parameters.

Methods in my prior pending applications may be implemented, including without limitation:

Individual Background Profile Factors (IBPF of users and SLF for use by ILS and/or by RLF in contemplating current and/or planned ICVMP program offers, benefits, etc that may or may not be related to the initial ICVMP;

An SLF “Performance Score” (An SLFPS), that records all SLF interactions with users deemed relevant, possibly including the timeliness of responses to demands for responses or other information within prescribed times as well as performance of various related and/or unrelated tasks and/or activities deemed relevant in all ways described in pending methods

An SLF “Performance Score Reporting System” (An SLF PSRS) is simply a planned dedicated search engine type function intended for use by users and possibly potential users for specific personal injury lawyers that may include specific SLFPS-related information that ILS may process and respond with an score ICVMP user-generated inquiries;

Built-Into Other Products or Services, membership programs etc, such as holders of preferred credit cards as a benefit to those preferred members, card holders, etc

Coordination of assets—Examples of assets being coordinated include ILS, RLF and others in the manner contemplated in the planned ICVMP;

A dedicated search engine with data that is externally and internally generated.

A dedicated search engine with specific “Individual Background Profile Factors” to assess and score individuals, companies, professionals, etc. This specific tool is well described in my pending applications, which are incorporated by reference herein. Additionally, attempts by selected lawyers/law firms to renegotiate the legal fee once they agree to accept a discounted legal fee will be recorded, possibly assigned a score and other wise be made available to users of the proposed service. Moreover, the time it takes for selected lawyers/law firms to reply or cooperate at any level in the proposed service along with specific replies to questions in surveys and the willingness to even respond to surveys that may be presented to lawyers/law forms by the service provider.

A Performance Score System

The service provider (ILS) will be in a position to accumulate information through the operation of the proposed service that will enable ILS to generate profiles and performance scores for every lawyer/law firm that is ever touched by ICVMP users. This data will continue to be accumulated through every single new sale of the ICVMP so as to enable ILS to grow a larger and larger database of users and of personal injury lawyers and law firms.

ILS data will be processed so as to offer ICVMP user-accessible information. For example, the data may be introduced in various forms for use in a dedicated search engine with very personal injury case-specific search parameters and search results that are highly relevant to significant personal injury cases, including information pertaining to other case comparisons and other information that may or may not be useful or relevant to their own pending personal injury case.

ILS may apply the score to the SLF as well to ILS to demonstrate how quickly we can generate a favorable outcome for ICVMP users.

ILS plans to develop and introduce the Performance Scoring System to benefit ICVMP users of the type described in earlier pending methods (see patent applications incorporated by reference above) once ICVMP users can effectively identify preferred personal injury lawyers in the context of the willingness or unwillingness of the proposed SLF to willingly accept the proposed terms and not haggle with RLF or ILS in the context of their reaction to the receipt of a proposed terms letter from RLF through the ICVMP, their timeliness or lack thereof in responding to prior ILS requests for acceptance of proposed terms, a demand for information that surveys the personal injury lawyer to a greater extent than is available by other means, etc.

There are also additional methods relating to highly complementary products that ICVMP users may desire to purchase from ILS. The products include a non-recourse loan to pay for unplanned emergency events such as deaths and even the purchase of the ICVMP, retirement products, and other financial, investment, insurance, and related products relevant for persons who are in a position to recover based on a legal claim.

In an embodiment, the percentage of the recovery used to repay the loan may be capped; such a cap would be relevant to small recoveries.

The methods described herein are operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means for performing each of the steps described herein, each of which means may include a processor executing instructions contained in programs which may be stored in a storage medium, such as a local memory.

Non-limiting examples of a method and system in accordance with an embodiment of the invention include the following. The provider of legal services is provided an economic incentive to offer reduced legal fees, in that the provider of legal services is relieved of the need to advance costs for collection of records. By contrast, known prior art non-recourse loans are offered after the legal services provider is engaged. Consumers may be aggregated, thereby affording greater economic leverage and affording the legal services provider reduced marketing costs. Loan proceeds may be disbursed directly to the record retrieval services provider, with no need to obtain payment from the consumer. Any risk of nonpayment in the peer-to-peer context may be offset, at least to some extent, by arranging for other benefits; use of peer-to-peer methods may also reduce the risk of nonpayment by providing an additional incentive for a customer to be cooperative.

It is an advantage that the lender pledges to fund the line of credit prior to retention of the attorney; accordingly, the attorney has an incentive to agree to a reduced rate. The loan is pre-approved, and the line of credit is triggered by the attorney's agreement. As the service provider reviews the case, the service provider can avoid any cases that appear to be unlikely to be successful.

A further advantage is that the relationship between the lender and the customer created by the non-recourse loan may be employed as the basis for other lending and other financial relationships.

While the foregoing invention has been described with reference to the above described embodiments, various modifications and changes can be made without departing from the spirit of the invention. Accordingly, all such modifications and changes are considered to be within the scope of the invention.

What is claimed is:

1. A method related to engagement of a provider of services, comprising the steps of:
receiving from a potential consumer of the services information related to a matter pertaining to the subject matter of the services;
storing the information in a storage medium;
communicating to a provider of services at least a portion of the stored information;
receiving an indication that the provider and the potential consumer have agreed that services will be provided;
agreeing with the potential consumer for a loan having a principal amount equal to selected expenses, the loan to be repaid exclusively out of any proceeds of the consumer arising out of the services; and
providing funds for the selected expenses, which selected expenses arise out of an event related to the subject matter of the services and are paid directly to a vendor.

2. The method of claim 1, wherein the services are legal services, and the subject matter of the services constitutes events relating to an injury to the consumer or a relative of the consumer.

3. The method of claim 1, wherein the portion of the information communicated to the provider excludes contact information for the customer.

4. The method of claim 3, further comprising, after the step of communicating, evaluating a response from the provider for compliance with selected criteria, and providing contact information to the provider responsive to the results of the evaluation.

5. The method of claim 4, wherein the criteria include timeliness and agreement to use of a selected provider for the services.

6. The method of claim 4, wherein the criteria include agreement to charge a fee to the customer no greater than a selected limit.

7. The method of claim 1, wherein the expenses are for obtaining documents.

8. The method of claim 1, wherein the expenses are funeral expenses.

9. A method related to engagement of a provider of services, comprising the steps of:
receiving from a potential consumer of the services information related to a matter pertaining to the subject matter of the services;
storing the information in a storage medium;
communicating to one or more designated potential lenders at least a portion of the stored information, including identifying information for the customer;
communicating to a provider of services at least a portion of the stored information, excluding contact information for the customer, and providing conditions for furnishing contact information;
receiving and evaluating a response from the provider;
receiving and evaluating one or more responses from potential lenders;
based on the evaluating step, providing customer contact information to the provider;
receiving an indication that the provider and the potential consumer have agreed that services will be provided; and
based at least on the received responses from the potential lenders, recording information relating to an agreement between the potential consumer for a loan from the one or more lenders having a principal amount equal to selected expenses, the loan to be repaid exclusively out of any proceeds of the consumer arising out of the services, and the loan proceeds to be paid directly to a vendor for the selected expenses.
